(19) United States
(12) Patent Application Publication
(10) Pub. No.: US 2013/0055658 A1
(43) Pub. Date: Mar. 7, 2013

(54) TELESCOPIC CRANE ARM

(71) Applicant: Johannes Steindl, Elsbethen (AT)

(72) Inventor: Johannes Steindl, Elsbethen (AT)

(21) Appl. No.: 13/605,185

(22) Filed: Sep. 6, 2012

(30) Foreign Application Priority Data
Sep. 7, 2011 (EP) 11007266.7

(51) Int. Cl. B66C 23/687

(52) U.S. Cl. 52/118

(57) ABSTRACT

Telescopic crane arm for a crane, in particular a mobile crane, with:

at least one boom, and

at least one boom extension that can be moved telescopically relative to the boom, and

at least one hydraulic line arranged in the crane arm for an implement that can be attached to the crane arm and operated hydraulically,

wherein the hydraulic line has at least one first tube and a second tube that is movable relative to the first tube, wherein a connection is formed from the first tube and/or the second tube to at least one oil compensation chamber arranged in the inside of the crane arm to compensate for effects of changing the length of the crane arm,

wherein the first tube, the second tube and the oil compensation chamber are formed in the inside of the boom extension.

The invention relates to a telescopic crane arm for a crane, in particular a mobile crane, with at least one boom and at least one boom extension that is telescopically movable relative to the boom and at least one hydraulic line arranged in the crane arm for an implement that can be attached to the crane arm and operated hydraulically, wherein the hydraulic line has at least one first tube and a second tube movable relative to the first tube, wherein a connection is formed from the first tube and/or the second tube to at least one oil compensation chamber arranged in the inside of the crane arm to compensate for effects of changing the length of the crane arm.

The invention also relates to a crane with at least one telescopic crane arm of the type specified.

A multitude of such telescopic crane arms for cranes are already known from the state of the art.

Thus, for instance U.S. Pat. No. 3,858,396 from 7 Jan. 1975 shows such a telescopic crane arm in which hydraulic lines are formed inside the crane arm, wherein the hydraulic lines can compensate for the effects of changing the length of the crane arm.

As an alternative to being formed in the crane arm, the hydraulic line, which is normally formed as an oil hose, is often also attached to the crane arm at several points. Because the crane arm is telescopic and because of the resultant change in the length of the crane arm, it is also necessary for the hydraulic hose to “grow” with changes in the length of the crane arm. This is normally achieved by the hydraulic hose forming loops when the telescopic crane arm is retracted and, during the extension of the boom extension, these loops decrease or unravel when the boom extension is being extended. A disadvantage of this is that the loops of the hydraulic line hang down from the crane arm and it is thus possible for this hydraulic line to be damaged—whether during manoeuvring of the crane arm or during extension or retraction of the boom extension.

An object of the invention is to specify a telescopic crane arm for a crane that is improved compared with the state of the art.

This object is achieved by a telescopic crane arm with the features of claim 1.

Because the first tube, the second tube and the oil compensation chamber are formed inside the boom extension, an extremely compact crane arm can be achieved unlike in the state of the art (U.S. Pat. No. 3,858,396), in which the crane arm is large, since the tubes and the oil compensation chamber are formed between the boom extension and the boom and not in the boom extension itself.

The disadvantages of using hoses can also be avoided through the use of tubes. For instance, to operate a harvester, very high pressures and amounts of litres are needed, which leads to extremely large dimensions if hoses are used. In turn, this leads to increased bending radii of the hoses, whereby a large crane arm is needed in order to allow these bending radii. If, on the other hand, the bending radius is made too small in order to permit use of a smaller crane arm, the life of the hose is greatly shortened. This leads to increased stoppages of the crane to replace the hose, and also to higher material costs and expenditure. If tubes are used, on the other hand, this is not the case, as they are capable of withstanding high pressure.

Further advantageous embodiments of the invention are defined in the dependent claims.

It has proved particularly advantageous if the oil compensation chamber is formed with a variable capacity, whereby an overall spatial capacity of the first tube, of the second tube and of the oil compensation chamber is of equal size in every movement position of the first tube relative to the second tube.

By forming an oil compensation chamber with a variable capacity, it is achievable that the pressure inside the hydraulic line can be kept constant in any extension position of the boom extension, as the overall spatial capacity of the second tube, of the first tube and of the oil compensation chamber always remains unchanged in total.

It can moreover preferably be provided that the oil compensation chamber is formed with a variable shape, whereby the oil compensation chamber changes the extension of its length in every movement position of the first tube relative to the second tube. It can thus be achieved that the oil compensation chamber increases its length with an extending crane arm or shortens its length with a retracting crane arm.

It can particularly preferably be provided that the oil compensation chamber is formed in or on the hydraulic line. This measure can contribute to the achievement of a compact design.

It has proved to be particularly advantageous if the crane arm has at least one boom cylinder for moving the boom extension relative to the boom.

According to a preferred embodiment, it can be provided that the hydraulic line is attached to the boom on the one hand and is attached to the boom extension on the other hand. By forming the hydraulic line with attachment points on the boom on the one hand and on the boom extension on the other hand, it can be achieved that the change in the length of the crane arm by the boom cylinder directly brings about a change in the length of the hydraulic line.

It can moreover preferably be provided that the boom cylinder is formed inside the boom extension. Specifically by forming the boom cylinder inside the boom extension, an extremely compact crane arm can be achieved in which there can moreover be the advantage that the boom cylinder itself is also protected against mechanical influences, as it is located inside the crane arm.

It has proved to be particularly advantageous if the hydraulic line is attached to the boom cylinder. The hydraulic line thus moves together with the boom cylinder.

It has proved to be particularly advantageous if two hydraulic lines are formed inside the boom extension. This can also contribute to a compact crane arm.

Moreover, it can preferably be provided that the first hydraulic line is attached to the second hydraulic line, whereby the first hydraulic line moves together with the second hydraulic line when the boom extension extends or retracts.

It can particularly preferably be provided that the first hydraulic line is formed as an oil supply line for an implement that can be attached to the crane arm and the second hydraulic line is formed as an oil return line for the implement that can be attached to the crane arm. It can be achieved by this measure that all hydraulic lines necessary for an implement that can be attached to the crane arm are formed protected inside the crane arm.

Specifically, protection is also sought for a crane with at least one telescopic crane arm according to at least one of the described embodiments.

Further details and advantages of the present invention are explained in more detail below with the help of the description of the figures with reference to the embodiment examples represented in the drawing. There are shown in:

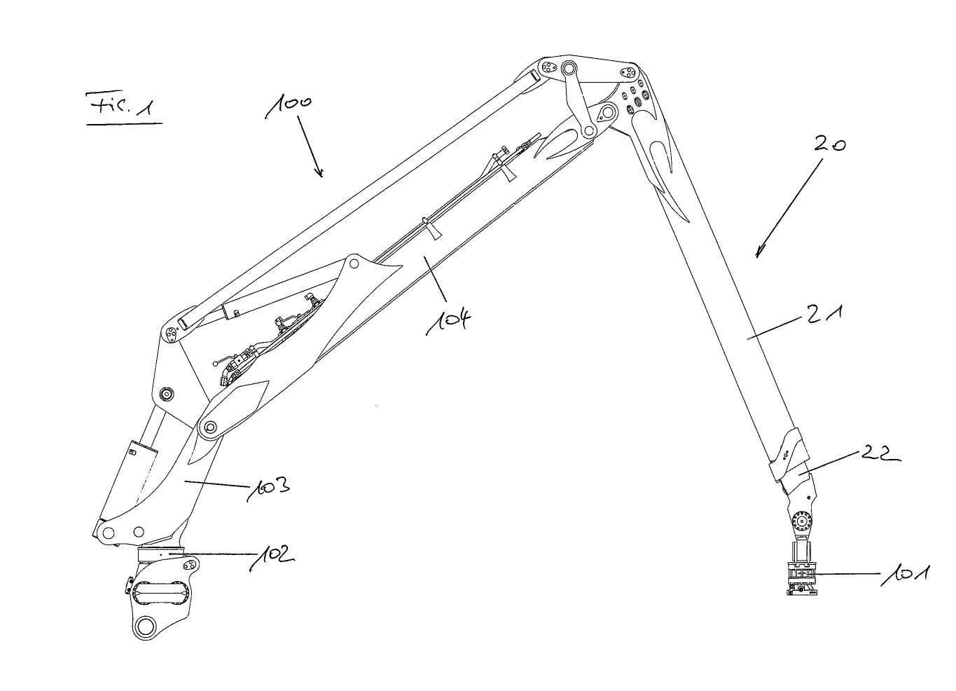

FIG. 1 a side view of a crane with telescopic crane arm

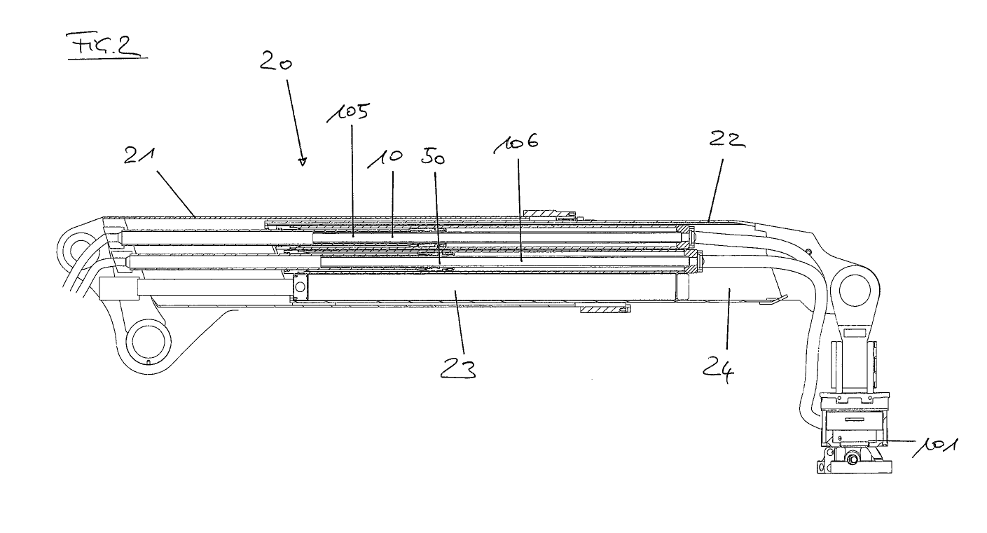

FIG. 2 a section through a telescopic crane arm

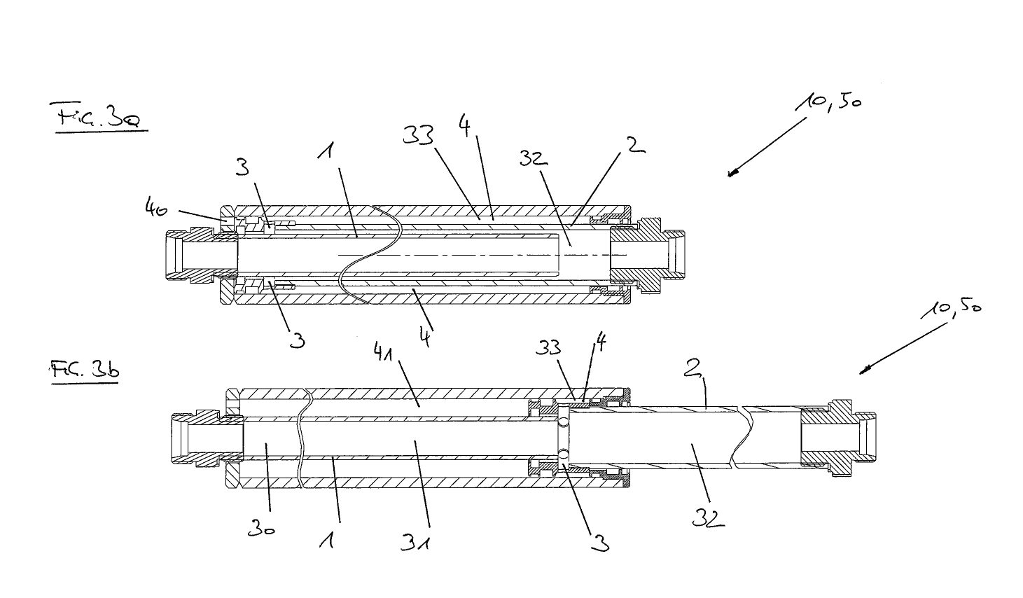

FIG. 3a a section through a retracted hydraulic line

FIG. 3b a section through an extended hydraulic line

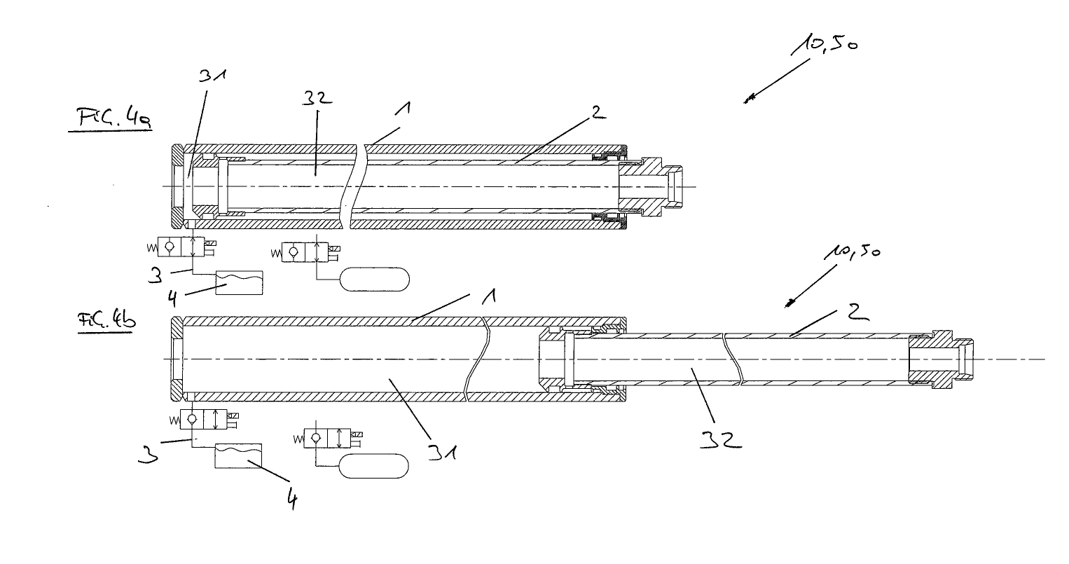

FIG. 4a a section through a variant of a retracted hydraulic line

FIG. 4b a section through a variant of an extended hydraulic line

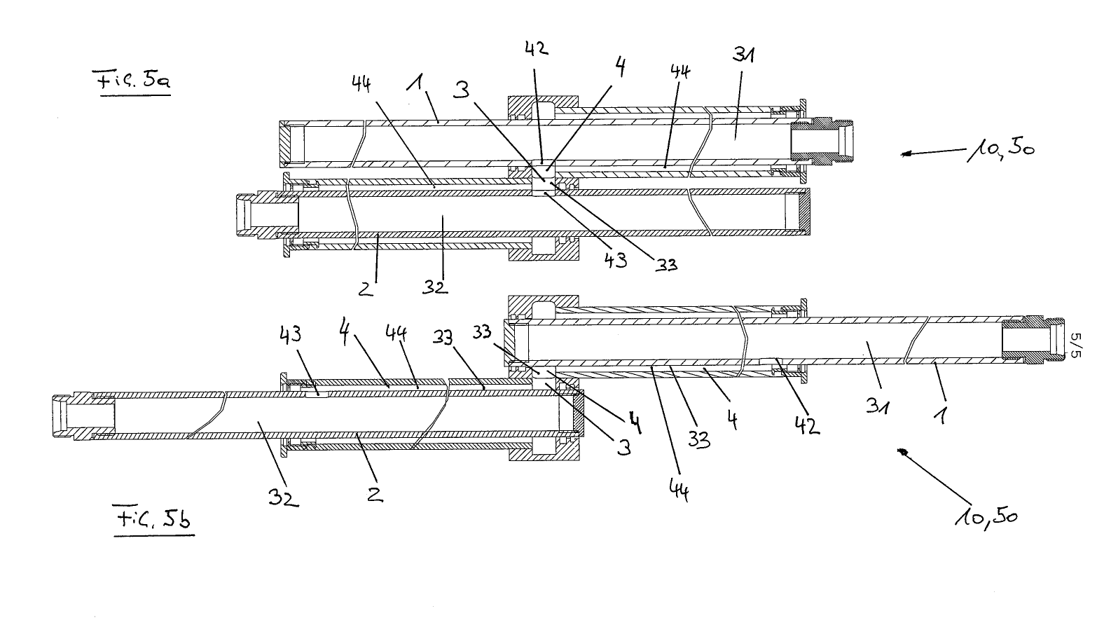

FIG. 5a a section through a further variant of a retracted hydraulic line

FIG. 5b a section through a further variant of an extended hydraulic line

FIG. 1 shows a crane 100 which in this preferred embodiment is formed as a mobile crane. The crane 100 has a crane pillar 102, and several booms 103, 104 and 21. The booms 104 and 21 can be swivelled about joints via several lifting cylinders.

A boom extension 22 that can be moved telescopically relative to the boom 21 is formed in the boom 21.

The implement 101—a rotator in this embodiment example—is attached to the crane arm 20. It is further envisaged to attach a tool to the rotator itself, a tool such as for instance the head of a wood harvester, which can be operated hydraulically for example. In this preferred embodiment, this tool would operate via hydraulic lines 10 and 50 (not shown, see FIG. 2). These hydraulic lines 10 and 50 are formed inside the crane arm 20 thus inside the boom 21 and the boom extension 22.

The boom extension 22 is extended in this preferred embodiment via the boom cylinder 23 not shown here (see FIG. 2), which is also formed inside the crane arm 20 thus inside the boom 21 and the boom extension 22.

FIG. 2 shows a section through the telescopic crane arm 20. The boom cylinder 23 and also the two hydraulic lines 10 and 50 are formed in the inside 24 of the boom extension 22.

If the boom cylinder 23 extends, this results in a change in the length of the crane arm 20, as the boom extension 22 is also extended with the extension of the boom cylinder 23.

This change in the length of the crane arm 20 by the boom cylinder 23 simultaneously acts on the hydraulic lines 10 and 50, the length of which also changes simultaneously. This is achieved by attaching the hydraulic lines 10 and 50 at one end in the boom 21 and at the other end to the inside (24) of the boom extension 22 so that one tube the second tube 2 or the first tube 1 (not shown, see FIGS. 3a and 3b, FIGS. 4a and 4b and FIGS. 5a and 5b) moves with the boom extension 22 simultaneously with the extension of this boom extension 22, whereas the other tube the second tube 2 or the first tube 1 remains in its position on the boom 21.

In a further embodiment example, the hydraulic line 10 or 50 is not attached to the boom 21 and to the boom extension 22, but that the hydraulic line 10 or 50 is attached to the boom cylinder 23 and extends or retracts together with it.

Naturally, it is likewise conceivable that one of the two hydraulic lines 10 and 50 is attached to the other hydraulic line 10 or 50 and moves together with it.

Of course, all possible combinations of the attachment of the hydraulic lines 10 and 50 to each other, to the boom 21, to the boom extension 22 and to the boom cylinder 23 are also conceivable and contribute to an extremely compact crane arm 20. If the hydraulic lines 10 and 50 are attached multiple times, such as for instance both to the boom cylinder 23 and to the boom 21 and also to the boom extension 22 and also to each other, the stability of the crane arm can additionally be increased.

In this preferred embodiment, the hydraulic line 10 is formed as an oil supply line 105 for the implement 101 attached to the crane arm 20 and the second hydraulic line 50 is formed as an oil return line 106 for the implement 101 attached to the crane arm 20. Naturally, it is also conceivable that these hydraulic lines 10 and 50 can also be used for other purposes, or it is also conceivable to form still further hydraulic lines in the inside 24 of the boom extension 22.

These design features lead to an extremely compact crane arm through substantially complete use of the internal space 24 of the boom extension 22. In this FIG. 2, the embodiment example of a hydraulic line 10 and 50 of FIGS. 3a and 3b is shown; naturally it is also possible to form the embodiment examples of FIGS. 4a and 4b as well as of FIGS. 5a and 5b in this crane arm 20 or this boom extension 22.

FIG. 3a shows a section through the hydraulic lines 10 and 50 in retracted state and FIG. 3b shows a section through the hydraulic line 10 or 50 in the extended state.

Because the hydraulic lines 10 and 50 are telescopic, the hydraulic line 10 or 50 can “grow” with a crane arm 20 not shown here (see FIG. 2), if this crane arm 20 is formed telescopic and its length changes.

The hydraulic line 10 or 50 has a first tube 1 and a second tube 2 that is movable relative to the first tube 1, wherein a connection 3 is formed from the first tube 1 and/or the second tube 2 to at least one oil compensation chamber 4 with a variable capacity 33, whereby an overall spatial capacity 30 of the second tube 2, of the first tube 1 and of the oil compensation chamber 4 is of equal size in every extension position of the second tube 2 relative to the first tube 1.

The overall spatial capacity 30 is made up of the second tube capacity 32, the first tube capacity 31 and the capacity 33 of the oil compensation chamber 4. Strictly speaking, the overall spatial capacity 30 also includes the capacity of the connection 3, but as this capacity of the connection 3 does not change, it need not be taken into account.

When the hydraulic line 10 is in the retracted state, the capacity 33 of the variable oil compensation chamber 4 is at its greatest and the second tube capacity 32 of the second tube 2 is at its smallest. If the second tube 2 is now moved relative to the first tube 1, the second tube capacity 32 increases and the capacity 33 of the oil compensation chamber 4 decreases, which is made possible because oil flows from the oil compensation chamber 4 via the connection 3 into the second tube 2. It can thereby be achieved that the oil pressure inside the hydraulic line 10 or 50 is constant in every extension position of the second tube 2 relative to the first tube 1.

In the hydraulic line 10 or 50 there is also the air opening 40 which opens the chamber 41, also with a variable capacity. This contributes to a preferred sliding behaviour of the first tube 1 relative to the second tube 2, as, without the air opening 40, a negative pressure would form in the chamber 41 during the extension of the hydraulic line 10.

In the embodiment example shown here, the second tube 2 is moved together with the boom extension 22 and the first tube 1 is attached, stationary, to the boom 21. It is clear to a person skilled in the art that the first tube 1 could also be moved together with the boom extension 22 and that the second tube 2 could be attached, stationary, to the boom 21.

In this preferred embodiment, the compensation chamber 4 is formed outside the first tube 1 and outside the second tube 2. Naturally, it is also conceivable that the oil compensation chamber 4 is formed between the two tubes 1 and 2. Moreover, it would also be conceivable for the oil compensation chamber 4 to be formed in the first tube 1 or in the second tube 2. In this preferred embodiment, the first tube 1 is moreover formed as an inner tube and the second tube 2 as an outer tube.

FIG. 4a shows a further embodiment example of a hydraulic line 10 or 50 in the retracted state. In this variant of a hydraulic line 10 or 50, the oil compensation chamber 4 is still formed inside 24 the boom extension 22 (not shown, see FIG. 2 for this), but not directly on the tubes 1 and 2. Nevertheless, the oil compensation chamber 4 is connected to the tubes 1 and 2 via the connection 3. If the two tubes 1 and 2 move relative to each other (as shown in FIG. 4b), oil enters the internal space of the first tube 1 from the oil compensation chamber 4 via the connection 3, whereby the first tube capacity 31 increases.

In this embodiment example too, the hydraulic line 10 or 50 has at least one first tube 1 and a second tube 2 that is movable in the first tube 1, wherein the connection 3 is formed from the first tube 1 to an oil compensation chamber 4 arranged inside 24 the boom extension 22 to compensate for effects of changing the length of the crane arm (20).

FIG. 5a and FIG. 5b show a further variant of an embodiment example for a hydraulic line 10 or 50. In this variant, both tubes 1 and 2 are moved during the extension of the boom extension 22 (not shown).

In the retracted state, the connection 3 exists between the two tubes 1 and 2 essentially straight from the tube opening 43 of the second tube 2 to the oil compensation chamber 4 and from the latter via the tube opening 42 of the first tube 1 into the first tube 1.

When the two tubes 1 and 2 are extended, the shape of the oil compensation chamber 4 changes. The connection 3 still exists via the tube opening 43 of the second tube 2 to the oil compensation chamber 4 and from the latter via the tube opening 42 of the first tube 1 into the first tube 1, the oil compensation chamber 4 was stretched by the expansion around the two channels 44.

In this embodiment example, the capacity 32 of the second tube 2 and the capacity 31 of the first tube 1 and the capacity 33 of the compensation chamber 4 does not change, either in total or individually, only the extension of the length of the compensation chamber 4 changes. The capacity 33 of the compensation chamber 4 is likewise constant, because the channels 44 are also filled when the two tubes 1 and 2 are in the retracted state.

Both in the embodiment example of FIGS. 3a and 3b and in the embodiment example of FIGS. 5a and 5b, the quantity of oil in the hydraulic line is constant in every telescopic position, i.e. there is no oil flow either at the inlet or at the outlet of the hydraulic line when the boom extension extends or retracts. In other words, the pressure is constant in the hydraulic line at all times in every position without the assistance of a pump or the like.

1. Telescopic crane arm for a crane, in particular a mobile crane, with:
at least one boom, and
at least one boom extension that can be moved telescopically relative to the boom, and
at least one hydraulic line arranged in the crane arm for an implement that can be attached to the crane arm and operated hydraulically,
wherein the hydraulic line has at least one first tube and a second tube that is movable relative to the first tube, wherein a connection is formed from the first tube and/or the second tube to at least one oil compensation chamber arranged in the inside of the crane arm to compensate for effects of changing the length of the crane arm,
characterized in that the first tube, the second tube and the oil compensation chamber are formed in the inside of the boom extension.

2. Crane arm according to claim 1, characterized in that the oil compensation chamber is formed with a variable capacity, whereby an overall spatial capacity of the first tube, of the second tube and of the oil compensation chamber is of equal size in every movement position of the first tube relative to the second tube.

3. Crane arm according to claim 1, characterized in that the oil compensation chamber is formed with a variable shape, whereby the oil compensation chamber alters the extension of its length in every movement position of the first tube relative to the second tube.

4. Crane arm according to claim 1, characterized in that the oil compensation chamber is formed in or on the hydraulic line.

5. Crane arm according to claim 1, characterized in that one of the two tubes is formed as an outer tube and one is formed as an inner tube.

6. Crane arm according to claim 1, characterized in that the crane arm has at least one boom cylinder for moving the boom extension relative to the boom.

7. Crane arm according to claim 1, characterized in that the hydraulic line is attached at one end to the boom and at the other end to the boom extension.

8. Crane arm according to claim 6, characterized in that the boom cylinder is formed in the inside of the boom extension.

9. Crane arm according to claim 8, characterized in that the hydraulic line is attached to the boom cylinder.

10. Crane arm according to claim 1, characterized in that two hydraulic lines are formed in the inside of the boom extension.

11. Crane arm according to claim 10, characterized in that the first hydraulic line is attached to the second hydraulic line.

12. Crane arm according to claim 10, characterized in that the first hydraulic line is formed as an oil supply line for an implement that can be attached to the crane arm and the second hydraulic line is formed as an oil return line for the implement that can be attached to the crane arm.

13. Crane with at least one telescopic crane arm according to claim 1.
